(19) United States
(12) Patent Application Publication
(10) Pub. No.: US 2010/0259955 A1
(43) Pub. Date: Oct. 14, 2010

(54) SOFT SWITCHING POWER CONVERTER

(75) Inventor: Ryuichi SHIMADA, Tokyo (JP)

Correspondence Address: INTERNATIONAL KNOWLEDGE ASSET OFFICE, 19400 Von Karman Ave. Suite 400, IRVINE, CA, 92612, US

(73) Assignee: TOKYO INSTITUTE OF TECHNOLOGY, Tokyo (JP)

(21) Appl. No.: 12/746,575

(22) PCT Filed: Dec. 8, 2008
(86) PCT No.: PCT/JP2008/072716

§ 371 Date: Jun. 10, 2010

(30) Foreign Application Priority Data
Dec. 11, 2007 (JP) 2007-320000

(51) Int. Cl. H02M 7/04

(52) U.S. Cl. 363/49

(57) ABSTRACT

The present invention provides a soft switching power converter that turns the switching operations of the semiconductor elements used for all the switching into soft switching operations with the use of a magnetic energy recovering switch that has a small-capacity magnetic energy storing capacitor connected between DC terminals of a bridge circuit formed with at least two reverse-conduction semiconductor switches. A high-frequency boost pulse voltage generated by the magnetic energy recovering switch is regarded as the voltage of a DC link portion. The soft switching power converter converts the voltage into DC or AC of arbitrary low frequency through a filter or a switching control unit. With this structure, the switching operations of the semiconductor elements used for all the switching are turned into soft switching operations. Accordingly, the power converter is capable of boosting or lowering the output voltage, and serves as a reversible power converter that is formed with a relatively small number of components and a simple control unit.

### TECHNICAL FIELD

The present invention relates to forward power conversions from AC power or DC power to DC power and reverse power conversions from DC power to AC power, and relates to a soft switching power converter that is capable of performing reverse conversions with the use of a power supply of a DC link that is a high-frequency boost pulse voltage generated by a function of a magnetic energy recovering switch to recover the magnetic energy without loss in both current directions.

### BACKGROUND ART

Various methods for converting DC to AC have been put into practical use. There has been a demand for smaller devices and higher efficiency. There is also a demand for a smaller number of components and simpler control operations. To reduce the sizes of components such as an insulating transformer, the switching frequency is made higher. As a result, the loss due to switching becomes larger. In a high-speed switching operation at a switching frequency higher than 10 kHz, the loss in voltage and current is much larger than the conduction loss of the semiconductor elements used for switching where the semiconductor elements are in a transient state between the on state and the off state.

While there is a demand for semiconductor elements appropriate for high-speed switching, a soft switching technique for making voltage or current, or both voltage and current to almost zero during an on/off operation of the semiconductor elements used for switching is an essential solution as a circuit technique.

Meanwhile, the inventor has suggested a circuit technique called a magnetic energy recovering switch that has already been granted (Japanese Patent No. 3,634,982, hereinafter referred to as “Patent Document 1”). The magnetic energy recovering switch includes a bridge circuit that is including four semiconductor elements that do not have a reverse blocking capability or are of a reverse-conduction type (hereinafter referred to as reverse-conduction semiconductor switches), and a capacitor that is connected between the DC terminals of the bridge circuit. The currents in both forward and backward directions can be turned on and off only by controlling the gates of the reverse-conduction semiconductor switches. Each two reverse-conduction semiconductor switches diagonally located in the bridge circuit is regarded as a pair. When at least one pair of reverse-conduction semiconductor switches are turned on or off at the same time, the capacitor absorbs the magnetic energy of the current, and the energy is released through the reverse-conduction semiconductor switches that are in the on state. In this manner, the current is recovered in the switch circuit.

### SUMMARY OF THE INVENTION

### Problems to be Solved by the Invention

An object of the present invention is to provide a power converter that turns switching operations of semiconductor elements used for all switching into soft switching operations, and is capable of boosting and lowering an output voltage. Another object of the present invention is to provide a reversible power converter that can be formed with a relatively small number of components and a simple control unit.

### Means for Solving the Problems

The present invention is a soft switching power converter that performs a conversion from AC power to DC power or a conversion from DC power to AC power through soft switching, and the object is achieved by the soft switching power converter including a boost pulse voltage generating unit 3 that uses an AC power supply or a DC power supply as an input power supply 1, and has the input power supply 1 input to AC input terminals a and b thereof via an AC inductor 2, the DC power supply reversing current polarity, a smoothing inductor 6 that is inserted in series between a DC output terminal c or d of the boost pulse voltage generating unit 3 and a DC power supply or a load 7, and smoothens and supplies a boost pulse voltage generated by the boost pulse voltage generating unit 3 to the DC power supply or the load 7, and a control unit 4 that controls the boost pulse voltage generating unit 3, the boost pulse voltage generating unit 3 including a bridge circuit formed with four reverse-conduction semiconductor switches S1, S2, S3, and S4, and a capacitor 31 that is connected between DC output terminals c and d of the bridge circuit, and recovers and stores magnetic energy of current at the time of current cutoff, the control unit 4 applying a control signal to gates so that at least one pair of the reverse-conduction semiconductor switches located on a diagonal of the bridge circuit are turned on and off at the same time, the control unit 4 setting an on/off period of the reverse-conduction semiconductor switches longer than a resonance period determined by a capacitance of the capacitor 31 and an inductance (Lac) of the AC inductor 2, a voltage of the capacitor 31 becoming zero through discharge in each cycle, a zero voltage being observed when the reverse-conduction semiconductor switches are turned off, a zero current being observed when the reverse-conduction semiconductor switches are turned on, the control unit 4 thereby realizing soft switching.

The object of the present invention is effectively achieved by the soft switching power converter further including a switching control unit 5 that is connected in parallel to the DC output terminals c and d of the boost pulse voltage generating unit 3, and performs on/off control alternately on voltages above and below a busbar based on a pulse width modulation (PWM) carrier signal synchronized with a generation period of the boost pulse voltage, the switching control unit 5 including one or a plurality of arms each connecting two semiconductor switches in series, the switching control unit 5 being controlled by the control unit 4.

Further, the object of the present invention is achieved by the soft switching power converter, wherein, when power to be supplied to the load 7 is DC, the number of the arms is one, and the boost pulse voltage is lowered and supplied to the load by turning on and off the semiconductor switches, when the power to be supplied to the load 7 is single-phase AC, the number of the arms is two, and control is performed by turning on and off the semiconductor switches, to generate a low-frequency single-phase AC voltage, when the power to be supplied to the load 7 is three-phase AC, the number of the arms is three, and control is performed by turning on and off the semiconductor switches, to generate a three-phase AC voltage, and when the power to be supplied to the load 7 is N-phase AC, the number of the arms is N, and control is performed by turning on and off the semiconductor switches, to generate an N-phase AC voltage.

Further, the object of the present invention is effectively achieved by the soft switching power converter, wherein, when the input power supply 1 is DC, the control unit 4 turns on and off only one pair of the reverse-conduction semiconductor switches (a pair of S1 and S3, or a pair of S2 and s4) located on a diagonal of the bridge circuit, while maintaining the other pair of the reverse-conduction semiconductor switches in an off state, to thereby control the reverse-conduction semiconductor switches to operate as diodes.

Further, the object of the present invention is effectively achieved by the soft switching power converter, wherein, the boost pulse voltage generating unit 3 includes: a half-bridge circuit that is formed with two series-connected reverse-conduction semiconductor switches S2 and S3 of the reverse-conduction semiconductor switches and two series-connected diodes, and two of the capacitors 31 that are respectively connected in parallel to the two series-connected diodes.

Further, the object of the present invention is effectively achieved by the soft switching power converter, wherein, when the input power supply 1 is a three-phase AC power supply, the boost pulse voltage generating unit 3 includes a three-phase full-wave bridge circuit that is formed with six of the reverse-conduction semiconductor switches in the form of three legs, each leg being formed with two series-connected reverse-conduction semiconductor switches of the reverse-conduction semiconductor switches, and a circuit that is connected between DC terminals of the three-phase full-wave bridge circuit, and has a first capacitor and a first diode that are connected in parallel, the parallel-connected first capacitor and the first diode being connected in series to a second capacitor and a second diode that are connected in parallel so that the first diode and the second diode are orientated in a forward direction, a midpoint of the series connection being connected to a neutral point of the three-phase AC power supply, and the reverse-conduction semiconductor switches of a direction of a three-phase AC current are selected from the legs each connecting two of the reverse-conduction semiconductor switches, and all the selected reverse-conduction semiconductor switches are turned on or off at the same time, to generate the boost pulse voltage between the DC terminals of the three-phase full-wave bridge circuit, a three-phase AC power conversion being thereby performed.

Further, the object of the present invention is effectively achieved by the soft switching power converter, wherein thyristors are used as the semiconductor switches of the switching control unit 51.

Further, the object of the present invention is effectively achieved by the soft switching power converter, wherein, instead of the smoothing inductor 6, a diode is used as a unit for smoothing the boost pulse voltage.

Further, the object of the present invention is effectively achieved by the soft switching power converter, wherein, when power MOSFETs each having a parasitic diode built therein are used as the four reverse-conduction semiconductor switches S1, S2, S3, and S4, a synchronization signal is transmitted at the time of reverse conduction of the reverse-conduction semiconductor switches, to reduce conduction loss.

Further, the object of the present invention is effectively achieved by the soft switching power converter, wherein, based on an input voltage or an input current of the boost pulse voltage generating unit 3, a voltage and a current of a DC output or an AC output switched through the pulse width modulation, and a voltage of the capacitor 31, the control unit 4 determines an on/off time ratio of the gate signal and a switching period, and performs on/off control on the reverse-conduction semiconductor switches.

Further, the object of the present invention is achieved by the soft switching power converter, wherein the arms of the switching control unit 5 are replaced with four series-connected semiconductor switches.

Further, the object of the present invention is effectively achieved by the soft switching power converter, wherein, when the input power supply 1 is three-phase AC, and the power to be supplied to the load 7 is three-phase AC, the reverse-conduction semiconductor switches are used as the semiconductor switches of the switching control unit 5.

### EFFECTS OF THE INVENTION

In a soft switching power converter according to the present invention, a near-zero voltage is observed when the semiconductor elements used for all the switching are turned off, and a near-zero current is observed when the semiconductor elements are turned on. Accordingly, there is no switching loss, and high-speed operations can be properly performed. Thus, high-frequency operations can be realized, and the power converter can be made smaller in size. Also, this power converter has the excellent advantage that it is capable of performing reverse power conversions from DC power to AC power, unlike a conventional power converter that performs forward power conversions from AC power to DC power through diode bridge inputs.

### BRIEF DESCRIPTION OF THE DRAWINGS

FIG. 1 is a diagram for explaining an operation of a DC boost pulse voltage generating unit with magnetic energy recovering switches.

FIG. 2 is a diagram showing the initial state of a current flow in the DC boost pulse voltage generating unit.

FIG. 3(A) is a diagram for explaining the current flow that is seen immediately after the reverse-conduction semiconductor switches S1 and S3 are turned off.

FIG. 3(B) is a diagram for explaining the current flow that is seen immediately after the reverse-conduction semiconductor switches S1 and S3 are turned on.

FIG. 4 shows the results of a computer simulation of the power supply current and the capacitor voltage shown in FIG. 1.

FIG. 5 shows the results of a computer simulation of the voltage and the current to be applied to a reverse-conduction semiconductor switch.

FIG. 6 is a circuit block diagram showing the fundamental structure of a soft switching power converter based on MERS according to the present invention.

FIG. 7 is a circuit block diagram of a single-phase AC-to-DC converter with a PFC function according to Embodiment 1 of the present invention.

FIG. 8 is a circuit block diagram showing an example of a gate control circuit for the reverse-conduction semiconductor switches according to Embodiment 1 of the present invention.

FIG. 9 is a block diagram showing the circuit and control of a conventional single-phase AC-to-DC converter with a PFC function.

FIG. 10 shows the results of a computer simulation of Embodiment 1 of the present invention.

FIG. 11 shows the results of a computer simulation of Embodiment 1 of the present invention, and shows the waveforms of the current and voltage to be applied to a reverse-conduction semiconductor switch of FIG. 7 (the current shown herein being tenfold).

FIG. 12(A) is a circuit diagram of a DC-to-DC converter according to Embodiment 2 of the present invention.

FIG. 12(B) shows the results of a computer simulation of Embodiment 2.

FIG. 13 is a circuit diagram of a three-phase AC-to-DC converter according to Embodiment 3 of the present invention.

FIG. 14 shows the results of a computer simulation of Embodiment 3 of the present invention.

FIG. 15 is a circuit block diagram of a single-phase AC-to-DC converter according to Embodiment 4 of the present invention.

FIG. 16 is a circuit diagram of a DC-to-three-phase AC converter according to Embodiment 5 of the present invention.

FIG. 17 shows the results of a computer simulation of Embodiment 5 of the present invention.

FIG. 18 shows the results of a computer simulation of Embodiment 5 of the present invention.

FIG. 19(A) is a circuit diagram of a DC-to-lowered-DC converter according to Embodiment 6 of the present invention.

FIG. 19(B) shows the results of a computer simulation of Embodiment 6.

FIG. 20 is a circuit block diagram of a DC-to-single-phase AC converter according to Embodiment 7 of the present invention.

FIG. 21 shows the results of a computer simulation of Embodiment 7 of the present invention.

FIG. 22 is a circuit diagram showing a case where four semiconductor switches connected in series are used as a semiconductor switch leg of the switching control unit 5.

FIG. 23(B) is a circuit block diagram of a DC-to-DC converter that uses a diode as a smoothing unit according to Embodiment 8 of the present invention.

FIG. 23(A) is a circuit block diagram of Embodiment 2 of the present invention.

FIG. 24 is a circuit block diagram of a three-phase AC-to-three-phase AC converter according to Embodiment 9 of the present invention.

FIG. 25(A) shows the results of a computer simulation of Embodiment 9 of the present invention.

FIG. 25(B) shows the timings of switching the reverse-conduction semiconductor switches and the low-speed polarity changing switches of Embodiment 9.

### PREFERRED EMBODIMENTS OF THE INVENTION

Preferred embodiments of the present invention will be described with reference to the accompanying drawings. In the drawings, like components, members, and processes are denoted by like reference numerals, and the same description will not be repeated. The embodiments do not restrict the present invention but are merely examples, and all the features and the combinations of the features described in the following embodiments are not necessarily essential in the present invention.

The present invention has a principal component that is the magnetic energy regeneration switch (hereinafter referred to as “MERS”) disclosed in Patent Document 1.

The MERS includes a bridge circuit formed with four reverse-conduction semiconductor switches and a capacitor connected between the DC terminals of the bridge circuit.

Forward and backward currents can be switched on or off only by performing gate control on the reverse-conduction semiconductor switches. With each two reverse-conduction semiconductor switches diagonally located in the bridge circuit being a pair, at least one of the two pairs of reverse-conduction semiconductor switches are turned on or off at the same time. As a result, the capacitor absorbs the magnetic energy from the current when the reverse-conduction semiconductor switches are turned off, and discharges the magnetic energy through the reverse-conduction semiconductor switches that are in the on state. In this manner, the single-phase full-bridge MERS as a switch circuit recovers the magnetic energy.

When two reverse-conduction semiconductor switches diagonally located in the bridge circuit in the MERS are turned on or off at the same time, a DC pulse voltage is generated at the capacitor, and the magnetic energy is accumulated as charge energy. The capacitor discharges charges in series with the power source. Further, more energy is generated from the power source. Accordingly, the voltage of the capacitor and the power supply current grow at each pulse. If there is no loss due to electric resistance, the capacitor voltage and the power supply current grow unlimitedly. In the switching operations of the reverse-conduction semiconductor switches at this point, a near-zero voltage is observed when the reverse-conduction semiconductor switches are turned off, and a near-zero current is observed when the reverse-conduction semiconductor switches are turned on. In this manner, so-called zero-voltage zero-current switching (soft switching) is performed.

Since a DC pulse voltage appears between both ends of the capacitor, the voltage is smoothened by a smoothing inductor to obtain a DC output. In this manner, DC or AC power can be converted to DC power. Further, it is possible to convert DC or AC power to a single-phase AC voltage or three-phase AC voltage with low-speed switches that switch in synchronization with the near-zero state of the voltage of the DC pulse voltage. Moreover, switches that are PWM-controlled may be used for switching, to obtain waveforms similar to fundamental waves (sine waves).

The operation to be performed by the single-phase full-bridge MERS to generate a boost pulse voltage is now described, with reference to the accompanying drawings.

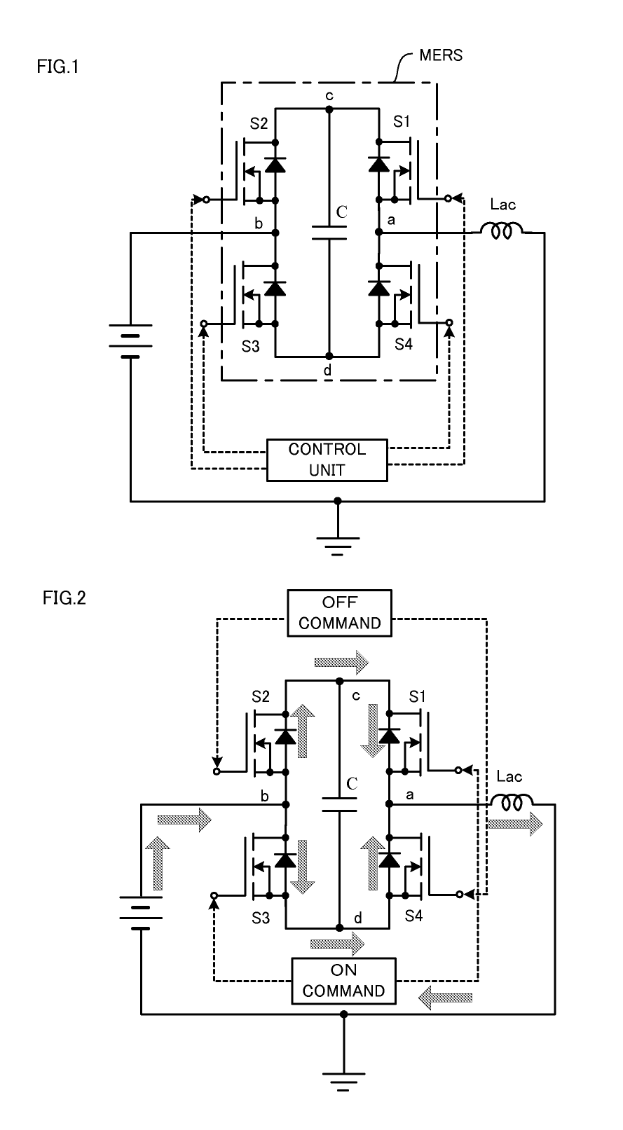

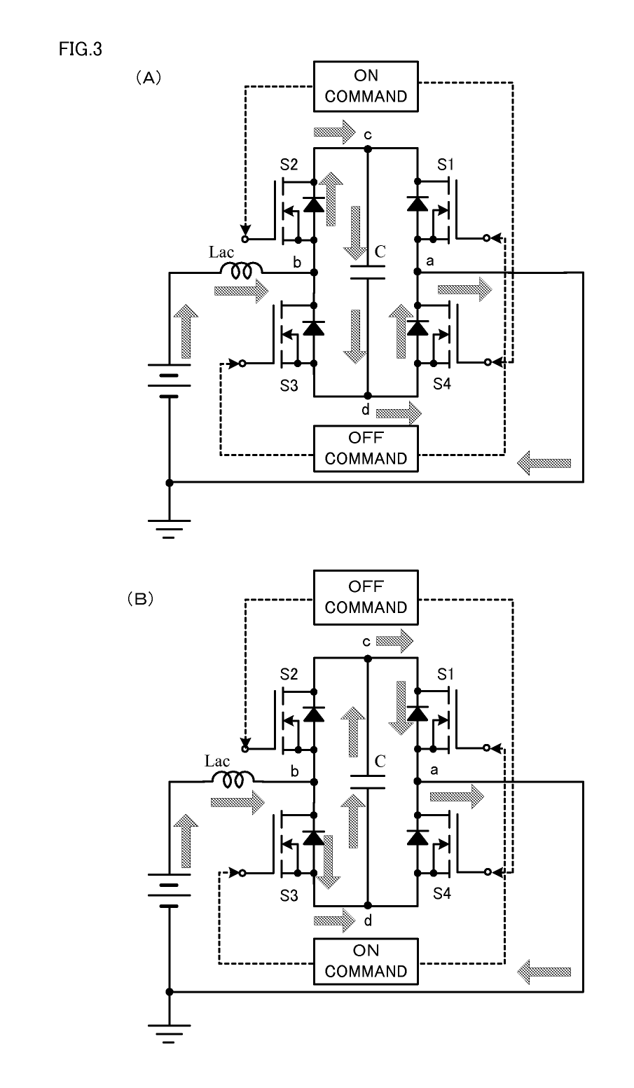

FIG. 1 shows a structure in which a DC power supply and an AC inductor 2 are connected in series to the AC terminals a and b of a MERS. FIG. 2 and FIGS. 3(A) and 3(B) illustrate changes of current flowing paths by the switching of the reverse-conduction semiconductor switches. The reverse-conduction semiconductor switches in FIGS. 1, 2, 3(A) and 3(B) are power MOSFETs having parasitic diodes contained therein.

In the following description with reference to the drawings, the paths through which the DC pulse voltage and the current flow between the DC terminals c and d when the reverse-conduction semiconductor switches S1 and S3 are turned on or off at the same time will be mainly described.

1) When the reverse-conduction semiconductor switches S1 and S3 are turned on where the capacitor C does not have a voltage, the current from the DC power supply flows through the following paths, and a parallel conduction state is formed: b—the parasitic diode of the reverse-conduction semiconductor switch S2-c—the reverse-conduction semiconductor switch S1-a; and b—the reverse-conduction semiconductor switch S3-d—the parasitic diode of the reverse-conduction semiconductor switch S4-a, as indicated by the arrows in FIG. 2.

2) When the reverse-conduction semiconductor switches S1 and S3 are turned off at the same time while a current is flowing from the power supply to an AC inductor Lac, the current from the DC power supply flows through the following path: b—the parasitic diode of the reverse-conduction semiconductor switch S2-c—the capacitor C-d—the parasitic diode of the reverse-conduction semiconductor switch S4-a, as shown in FIG. 3(A). The current then flows into the capacitor C, to charge the capacitor C.

3) When the voltage of the capacitor C is made higher by the charging from the power supply, the capacitor C and the AC inductor Lac resonate, and the magnetic energy of the AC inductor Lac is transferred to the capacitor C. At this point, the current stops flowing.

Accordingly, even when the flowing current is cut off by turning off the reverse-conduction semiconductor switches S1 and S3 at the same time, a voltage is not immediately generated at the capacitor C, and the voltage becomes gradually higher while the capacitor C is charged. The increase rate of the voltage of the capacitor C is determined by a resonance period calculated from the capacitance of the capacitor C and the inductance of the AC inductor Lac. As long as the increase rate of the capacitor voltage is sufficiently lower than the switching on-and-off rate of the reverse-conduction semiconductor switches, it is safe to say that a near-zero voltage is realized when the reverse-conduction semiconductor switches S1 and S3 are turned off.

The voltage between both ends of the capacitor C appears between the DC terminals c and d, and a DC pulse voltage is generated in synchronization with the switching on and off of the gates of the reverse-conduction semiconductor switches. In a case where there is no load resistance as in FIG. 1, the voltage between both ends of the capacitor C grows unlimitedly if the switching on and off of the gates of the reverse-conduction semiconductor switches is repeated. As a result, the capacitor voltage and the value of flowing current both keep increasing. When the capacitor C is charged to the maximum, the current flowing is stopped.

4) When the reverse-conduction semiconductor switches S1 and S3 are again turned on, a current does not flow in the path extending through the parasitic diodes of the reverse-conduction semiconductor switches S2 and S4, as shown in FIG. 3(B), since there is the charging voltage in the capacitor C. Instead, the released current from the capacitor C flows into the AC inductor Lac, passing through the following path: b—the reverse-conduction semiconductor switch S3-d—the capacitor C-c—the reverse-conduction semiconductor switch S1-a. Since there is the AC inductor Lac, the amount of current increases due to resonance between the capacitor C and the AC inductor Lac when the reverse-conduction semiconductor switches S1 and S3 are turned on. Therefore, it is safe to say that a near-zero current is realized when the reverse-conduction semiconductor switches S1 and S3 are turned on.

5) After the capacitor C completely discharged, and the voltage between both ends of the capacitor C becomes almost zero, the current from the DC power supply again flows through the following paths, and a parallel conduction state is formed: b—the parasitic diode of the reverse-conduction semiconductor switch S2-c—the reverse-conduction semiconductor switch S1-a; and b—the reverse-conduction semiconductor switch S3-d—the parasitic diode of the reverse-conduction semiconductor switch S4-a, as shown in FIG. 2. Thereafter, the above procedures are repeated.

Next, the operation to be performed by the MERS to generate a boost pulse voltage is described through a computer simulation.

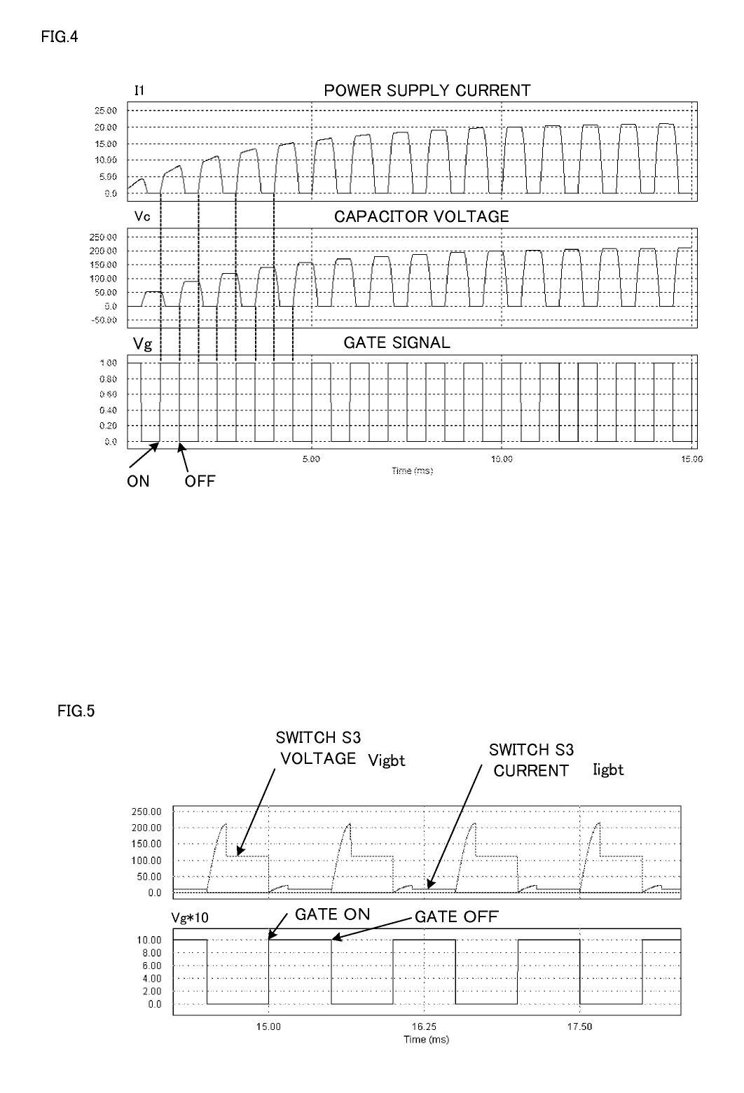

FIG. 4 shows the waveforms of the power supply current I1, the capacitor voltage Vc, and the signal (the gate signal) Vg for switching on and off the gates of the reverse-conduction semiconductor switches.

More specifically, FIG. 4 shows the results of a computer simulation performed when the circuit constants are set as follows in the circuit illustrated in FIG. 1.

1. Vdcin: the voltage of the DC power supply 10 V

2. L: the inductance of the AC inductor Lac 1 mH

3. C: the capacitance of the capacitor 10 micro-F

4. f: the on/off frequency of the gates of the reverse-conduction semiconductor switches S1 and S3, 1 kHz (T: period—1 millisecond)

5. R: the DC resistance of the AC inductor Lac 0.5 Ω.

FIG. 4 illustrates a state where the capacitor voltage Vc and the power supply current I1 grow with each pulse. A voltage several times as high as the power supply voltage Vdcin is generated at the capacitor C. At the capacitor voltage Vc, the current increases until the input from the power supply becomes balanced with the loss at the DC resistance R of the AC inductor Lac. The voltage Vdcin of the DC power supply is up to 10 V, the capacitor voltage Vc is up to 215 V, and the power supply current I1 is up to 21 A.

FIG. 5 shows the waveforms of the voltage and current and the gate signal to be applied to the reverse-conduction semiconductor switch S3 in the state illustrated in FIG. 4. As can be seen from FIG. 5, when the reverse-conduction semiconductor switch S3 is turned off, switching is performed at a near-zero voltage, and when the reverse-conduction semiconductor switch S3 is turned on, switching is performed with a near-zero current. In other words, soft switching is performed.

As described in the description of the above computer simulation, the MERS can generate a current pulse at an AC terminal and a voltage pulse at a DC terminal. Here, the reverse-conduction semiconductor switches realize zero-voltage zero-current switching, regardless of the size of current. In a switching operation without loss, the capacitor voltage and the flowing power supply current grow until the input from the power supply become balanced with the loss at the electric resistance.

Further, the capacitor voltage Vc is now described in greater detail with the use of formulas.

Where L indicates the inductance of the AC inductor Lac, I indicates the current, C indicates the capacitance of the capacitor C, and Vc indicates the voltage of the capacitor C, the magnetic energy of the AC inductor Lac and the electrostatic energy of the capacitor are transduced mutually without loss. Therefore, the following formula (1) is satisfied:

C·Vc²/2=L·I²/2 (1)

Accordingly, the relationship between the capacitor voltage Vc and the current I is satisfied by the following equation (2):

Vc={√(L/C)}I (2)

Since the final value of the steady current Is is determined by the DC resistance R of the AC inductor Lac, the following equation (3) is satisfied:

Is=V/R (3)

Accordingly, the following equation (4) is also satisfied:

Vc=(Z/R)V, provided Z=√(L/C) (4)

As is apparent from the above equation (4), the capacitor voltage Vc is multiplied by the value equivalent to the ratio between the surge impedance Z of the power supply voltage and the DC resistance R of the AC inductor Lac.

With Ts indicating the time required before the capacitor voltage Vc settles in a steady state, Ts is calculated by adding up the pulse-off times of the time constants of L and R. Accordingly, Ts approximates the value obtained by dividing the time constant (L/R) by the on/off ratio (Duty), which is expressed by the following equation (5):

Is≈(L/R)/Duty (5)

The circuit constants of FIG. 4 are assigned into the above equation (5). Since L is 1 mH and R is 0.5Ω, the time constant (L/R) becomes 2 milliseconds. Since the on/off ratio (Duty) is 0.5, the time Ts is calculated to be 4 milliseconds. The steady state of the time constant is defined as approximately 63% of 215 V, which is the maximum voltage of the capacitor voltage Vc. Therefore, it is the time when the capacitor voltage Vc becomes approximately 135V. This time is the time when the capacitor voltage Vc is approximately 135 V in the waveforms shown in FIG. 4, as can be seen from the drawing.

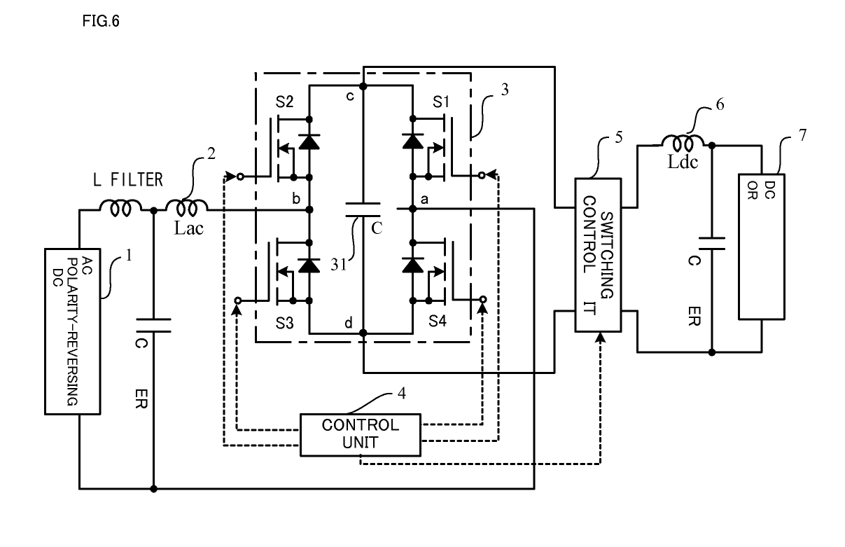

FIG. 6 is a circuit diagram showing the fundamental structure of a soft switching power converter according to the present invention. An input power supply 1 is an AC power supply or a DC power supply that reverses its current polarity. The input power supply 1 includes a boost pulse voltage generating unit 3 that generates a boost pulse voltage to be input to its AC input terminals a and b via an AC inductor 2, a switching control unit 5 that is connected to the DC output terminals c and d of the boost pulse voltage generating unit 3, and supplies the boost pulse voltage generated from the boost pulse voltage generating unit 3 to the DC power supply or a load 7 via a smoothing inductor 6, and a control unit 4 that controls the boost pulse voltage generating unit 3 and the switching control unit 5. The load 7 may be either an AC load or a DC load.

The boost pulse voltage generating unit 3 includes a bridge circuit formed with four reverse-conduction semiconductor switches S1, S2, S3, and S4, and a capacitor 31 that is connected between the DC output terminals c and d of the bridge circuit, and recovers and stores the magnetic energy of current.

The control unit 4 applies control signals to the gates, so that at least one pair of reverse-conduction semiconductor switches located on a diagonal of the bridge circuit are turned on and off at the same time. The control unit 4 also makes the on/off periods of the reverse-conduction semiconductor switches longer than the resonance period determined by the capacitance C of the capacitor 31 and the inductance Lac of the AC inductor 2. With this arrangement, the voltage of the capacitor 31 becomes almost zero, releasing in each half cycle. As a result, a near-zero voltage is observed when the reverse-conduction semiconductor switches are turned off, and a near-zero current is observed when the reverse-conduction semiconductor switches are turned on. In this manner, soft switching is realized.

The capacitor 31 of the power converter according to the present invention simply stores the magnetic energy of the AC inductor 2. How to use the capacitor 31 is completely different from how to use the capacitor of a conventional voltage-type inverter. In a conventional voltage-inverter, the capacitor is used as a voltage source, and therefore, constantly holds voltage. After a current is cut off, voltage is simultaneously generated at the semiconductor elements to be used for switching. As a result, hard switching is performed.

The capacitor 31 of the power converter according to the present invention sets the pulse periods of the gates of the reverse-conduction semiconductor switches, so that the voltage of the capacitor 31 is reduced to a near-zero voltage in each half cycle. The capacitor 31 characteristically resonates with the AC inductor 2.

The capacitance C of the capacitor 31 is a capacitance that is determined by the resonant frequency with respect to the inductance Lac of the AC inductor 2. As a result, the capacitance C of the capacitor 31 can be made much smaller than the capacitance of the voltage-source capacitor of a conventional voltage-type inverter.

The voltage of the capacitor 31 oscillates in synchronization with the pulse period of the gate signals of the reverse-conduction semiconductor switches, to recover the magnetic energy. The voltage of the capacitor 31 is boosted from the power supply, and a DC boost pulse voltage having a near-zero voltage period appears between the DC output terminals c and d.

The switching control unit 5 has one or more arms each connecting two semiconductor switches in series. In synchronization with the generation period of the boost pulse voltage, the switching control unit 5 alternately turns on and off the voltages above and below the busbar, based on a pulse-width-modulation (PWM) carrier signal.

In a case where the power to be supplied to the load 7 is DC power, only one arm is used, and a DC voltage is lowered and supplied to the load 7 by turning on and off the semiconductor switches.

In a case where the power to be supplied to the load 7 is single-phase AC power, two arms are used, and a low-frequency single-phase AC voltage is generated by controlling the switching on and off of the semiconductor switches.

In a case where the power to be supplied to the load 7 is three-phase AC power voltage, three arms are used, and a three-phase AC voltage is generated by controlling the switching on and off of the semiconductor switches.

In a case where the power to be supplied to the load 7 is N-phase AC power, N arms are used, and a N-phase AC voltage can be generated by controlling the switching on and off of the semiconductor switches.

In the following Embodiments, the N-phase AC is indicated by three-phase AC. The L filter and the C filter that are provided on the side of the AC input terminal and on the side of the DC output terminal, respectively, are designed to eliminate signals of unnecessary frequencies, and obtain power of desired frequencies.

### Embodiment 1

### Embodiment of a Single-Phase AC-to-Boost DC Conversion with a PFC Function

A soft switching power converter according to Embodiment 1 of the present invention is now described.

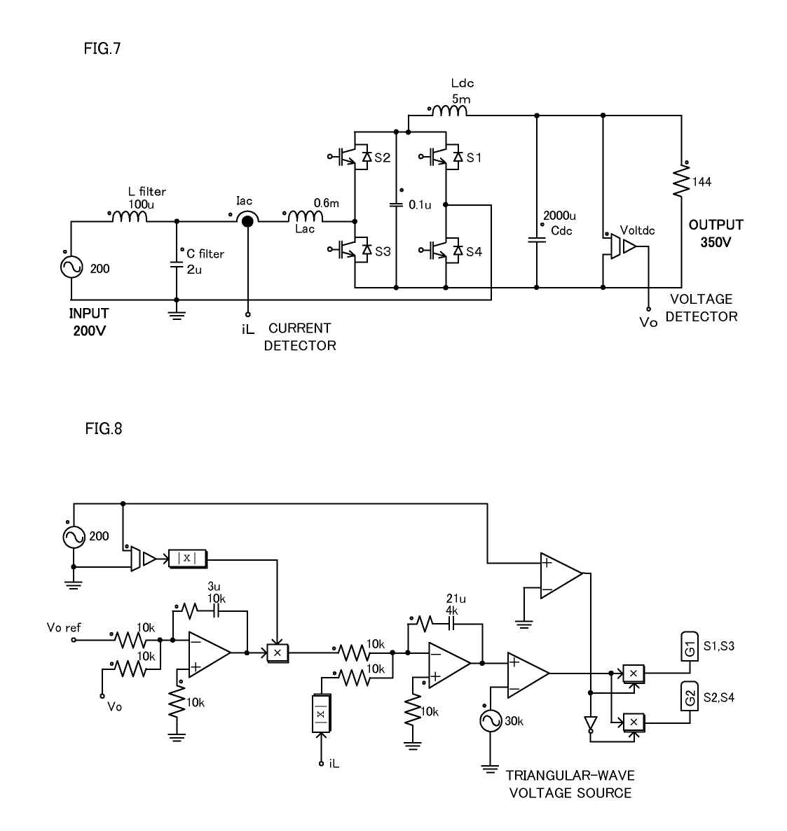

FIG. 7 shows an example of a structure applied to AC-to-boost DC conversion with a PFC (Power Factor Correction) function. FIG. 8 is a block diagram of a gate control circuit that supplies control signals to the gates of the four reverse-conduction semiconductor switches (S1, S2, S3, and S4) in FIG. 7.

More specifically, in FIG. 7, the output is approximately 1 kW, and a PFC function is provided to improve the waveform of the AC current to be input when the AC current is converted to a boost DC current. The capacitor 31 connected between the DC terminals c and d of the bridge circuit in the boost pulse voltage generating unit 3 of FIG. 6 is a capacitor having a capacitance C of 0.1 micro-F. The switching control unit 5 shown in FIG. 6 is not employed, and the DC boost pulse voltage is connected to a DC load via a smoothing inductor Ldc.

In FIG. 7, in a power conversion from AC power to DC power, the switching loss is reduced, as soft switching is realized where a zero voltage is observed when the reverse-conduction semiconductor switches are turned off, and a-zero current is observed when the reverse-conduction semiconductor switches are turned on. Compared with the case of a conventional art (described later), the number of semiconductor elements through which the current passes can be reduced. Accordingly, the AC-to-DC conversion efficiency can be made higher.

FIG. 8 illustrates a situation where a function to detect the voltage and current of an AC power supply is provided, one of the pairs of reverse-conduction semiconductor switches (the pair of S1 and S3, and the pair of S2 and S4) located on the diagonal of the bridge circuit has on-gates, the other one of the pairs have off-gates, and a gate signal for alternately switching the on/off states of the pairs is transmitted according to the current direction of the AC power supply. This is a feature that is not seen in the conventional art (described later).

In a case where power MOSFETs containing parasitic diodes are used as the reverse-conduction semiconductor switches of FIG. 7, the on-resistance at the MOSFET element portions is smaller than the junction voltage at the parasitic diode portions. Accordingly, synchronization signals for making the gates of the MOSFET element portions on-gates are transmitted when reverse conduction is caused by the parasitic diodes, so that the conduction loss can be further reduced.

FIG. 9 is a circuit block diagram of an AC-to-boost DC conversion with a PFC function according to a conventional art. This structure characteristically includes a PFC circuit that improves the power factor and waveform of the input current with a boost-up circuit that performs high-speed switching when AC power is converted to DC power.

More specifically, FIG. 9 illustrates a situation where, after diode rectification is performed, hard switching is performed at 30 kHz, which is sufficiently higher than the input frequency, and the input current is controlled. After AC power is rectified by a diode bridge, current amplification modification is performed when flyback boosting is performed, so that the waveform of the input current becomes similar to the waveform of the voltage. As the PFC control is performed to make the input current similar to the fundamental wave (the sine wave), this process is normally called PAM (Pulse Amplitude Modulation) control. The boost pulse voltage is then transferred to a voltage source capacitor via a smoothing circuit as needed, and is sufficiently smoothened to be DC power. This method excels in that only one semiconductor element is required for the high-speed switching. However, by this method, hard switching is performed, and large loss is caused in voltage and current. This method is also disadvantageous in that the forward conduction loss of the diodes becomes larger by the amount equivalent to three elements, due to the diode bridge (via two diode elements at the time of conduction) and the addition of one diode for blocking a flyback reverse current. Further, a reverse conversion from DC to AC cannot be performed.

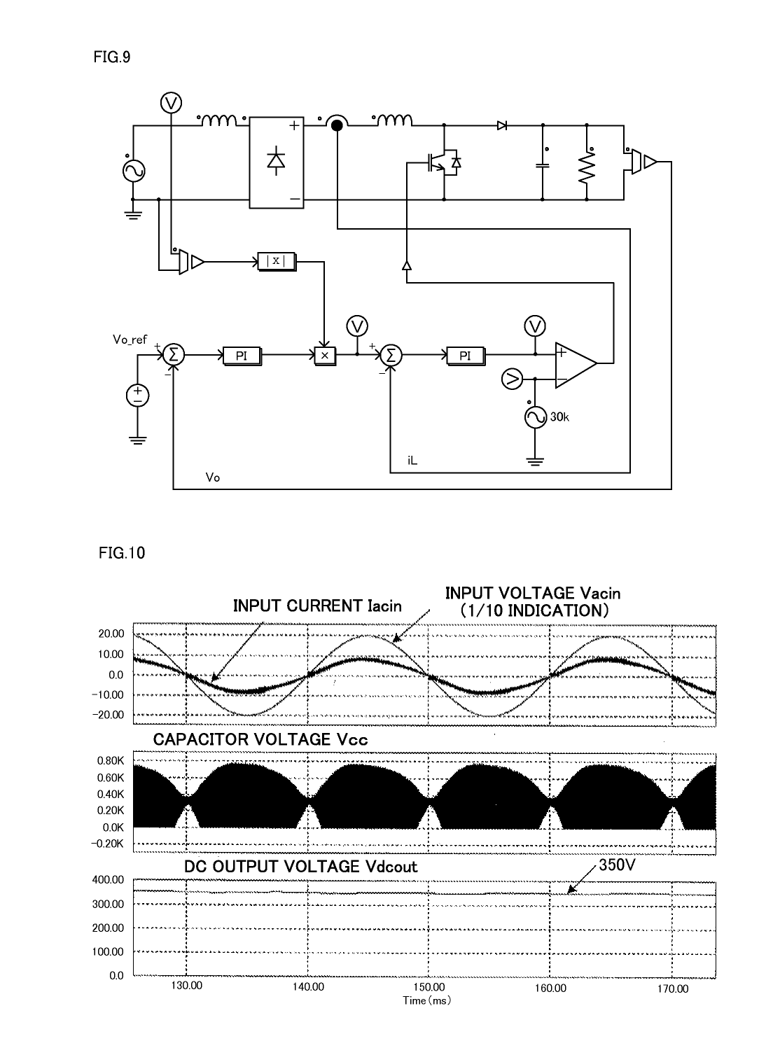

FIG. 10 shows the waveforms of the input AC current Iacin, the input AC voltage Vacin, the capacitor voltage Vcc, and the output DC voltage Vdcout of FIG. 7 ( 1/10 of the current being shown in the drawing).

More specifically, FIG. 10 shows the results of a computer simulation that is performed where the circuit constants in the circuit of FIG. 7 are set as follows:

1. Reverse-conduction semiconductor switches S1, S2, S3, and S4 (the semiconductor elements used being IGBTs and diodes connected in inverse-parallel to the IGBTs, with the conduction loss of each element being not considered)

2. Lac: AC inductor 0.6 mH

3. Ldc: smoothing inductor 5 mH

4. Load: DC load 144 S2.

5. Cdc: smoothing capacitor 2000 micro-F

6. AC power supply: 50 Hz, 200 Vrms

7. Capacitor: 0.1 micro-F

Other than the above, filter circuits (C filter of 2 micro-F, L filter of 100 micro-H) are added to the AC side. An output DC voltage of 350 V is obtained from the input AC voltage of 200 Vrms.

FIG. 11 shows the waveforms of the voltage VP3 and the current I to be applied to the reverse-conduction semiconductor switch S3 in the situation illustrated in FIG. 10 (the current shown in the drawing being tenfold). As can be seen from FIG. 11, switching is performed at a near-zero voltage when the reverse-conduction semiconductor switch S3 is turned off, and switching is performed with a near-zero current when the reverse-conduction semiconductor switch S3 is turned on. In other words, soft switching is performed.

In the soft switching power converter according to Embodiment 1 of the present invention, on the other hand, AC is not rectified by a diode bridge. Instead, AC can be input directly to the soft switching power converter, and an AC-to-DC conversion can be performed. A high-frequency pulse link generated by utilizing the function of the MERS to generate a boost pulse voltage is used to perform an AC-to-boost DC conversion with a PFC function. The generation of a boost pulse voltage by the MERS causes no loss. A zero voltage is observed when the semiconductor elements used for the switching are turned off, and a zero current is observed when the semiconductor elements are turned on. Accordingly, soft switching is performed. Thus, it is possible to obtain a smaller-size device that has no switching loss, is appropriate for high-speed switching operations, and can cope with higher frequencies. Further, it is possible to perform a reverse conversion from DC to AC, which cannot be performed with a conventional diode bridge input.

### Embodiment 2

### Operations of the Reverse-Conduction Semiconductor Switches of a MERS at the Time of a DC Input

A soft switching power converter according to Embodiment 2 of the present invention is now described.

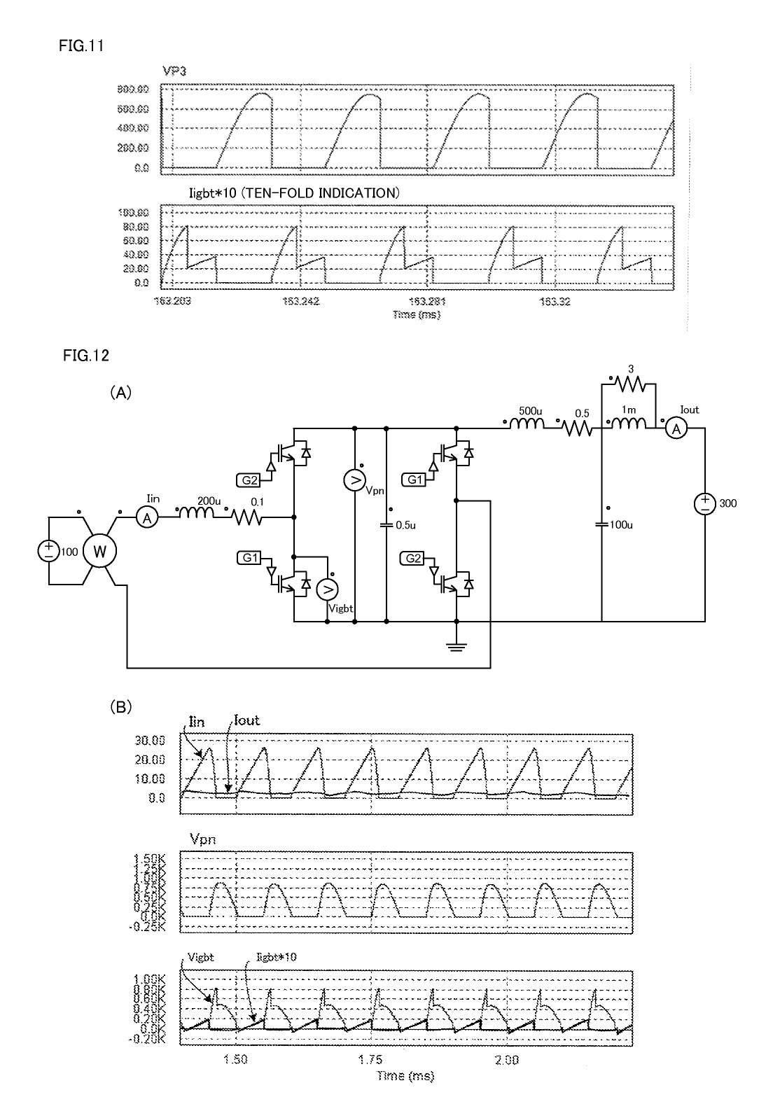

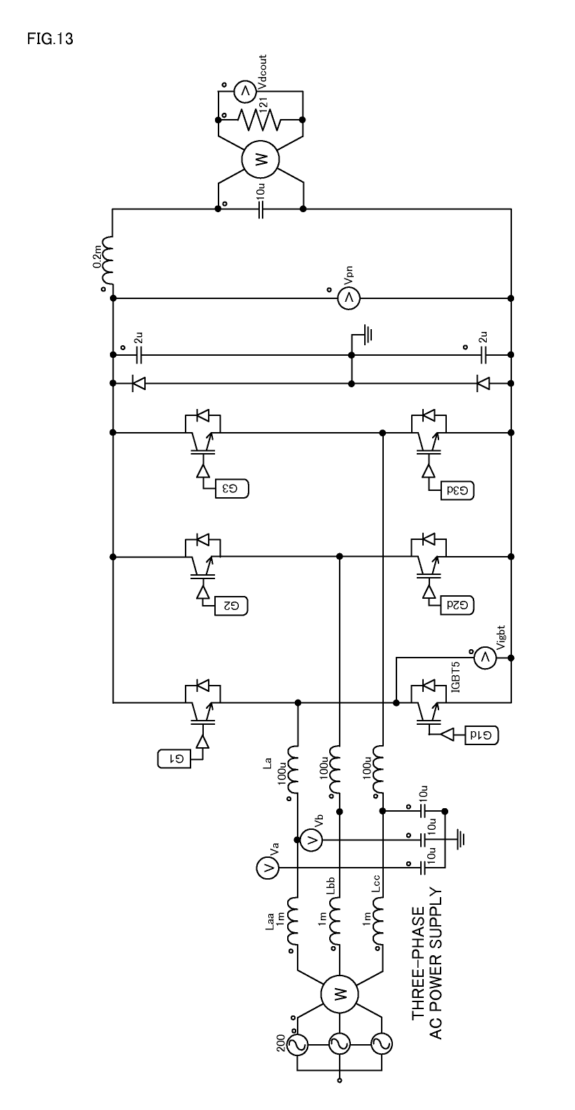

FIG. 12(A) shows an embodiment of a DC-to-DC conversion. FIG. 12(B) shows the results of a computer simulation of the Embodiment illustrated in FIG. 12(A).

More specifically, the Embodiment illustrated in FIG. 12(A) is a modification of Embodiment 1 (FIG. 7) of the present invention, and the input AC power supply of FIG. 7 is replaced with a DC power supply. In this Embodiment, reverse conversions can be performed, regardless of differences in voltage. FIG. 12(A) is a circuit block diagram of a boost conversion from a DC of 100 V to a DC of 300V. FIG. 12(B) shows the waveforms of the input DC current Iin, the output DC current Iout, the busbar PN voltage Vpn, and the voltage Vigbt and the current I to be applied to the reverse-conduction semiconductor switch S1 shown in FIG. 12(A) (the currents shown in the drawing being tenfold).

### Embodiment 3

### Where Three-Phase AC Power is Input

A soft switching power converter according to Embodiment 3 of the present invention is now described.

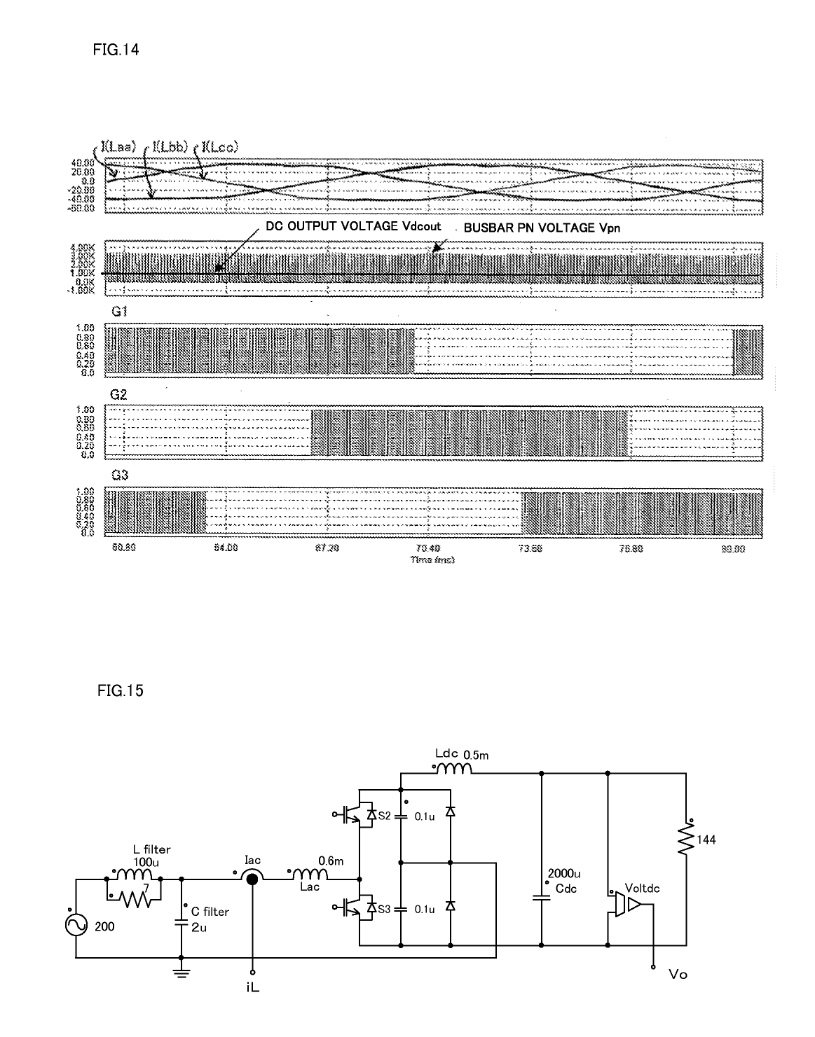

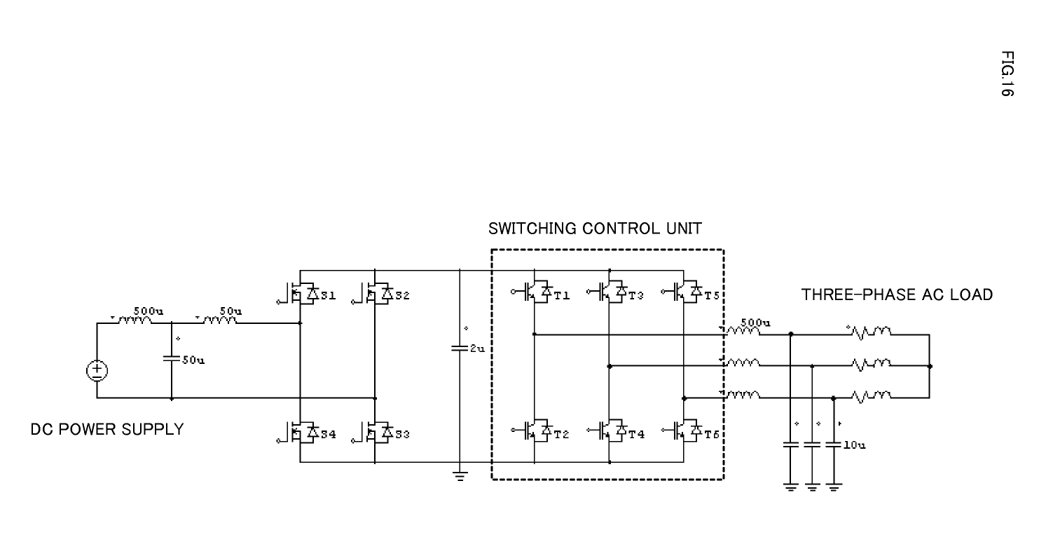

FIG. 13 shows an embodiment of a power conversion from three-phase AC to DC. FIG. 14 shows the results of a computer simulation of the conversion illustrated in FIG. 13.

More specifically, FIG. 13 illustrates a case where the single-phase AC input of Embodiment 1 (FIG. 7) of the present invention is replaced with a three-phase AC input. In FIG. 13, the magnetic energy recovering switch is used as the boost pulse voltage generating unit. The magnetic energy recovering switch includes a three-phase full-wave bridge circuit that is formed with six reverse-conduction semiconductor switches in the form of three legs, with each one leg connecting two reverse-conduction semiconductor switches in series. A first capacitor and a first diode that are connected in parallel are connected between the DC terminals of the three-phase full-wave bridge circuit. The first capacitor and the first diode connected in parallel are connected in series to a second capacitor and a second diode that are connected in parallel. With this arrangement, the first diode and the second diode are orientated in the forward direction. Also, the midpoint of the series connection is connected to the neutral point of the three-phase AC. In this structure, three-phase power conversions can be performed.

FIG. 14 shows the waveforms of the input three-phase AC currents ILaa, ILbb, and ILcc, the busbar PN voltage Vpn, the DC output voltage Vdcout, and the gate signals G1, G2, and G3 shown in FIG. 13. More specifically, the gate signals are turned on and off at 10 kHz at high speed. Constant time ratio (duty ratio) control is performed through simple switching on and off, so that the power factor of the input three-phase AC current is 1, and the fundamental wave (the sine wave) is obtained. An output DC voltage 1000 V, 10 kW, is obtained from the input three-phase AC voltage 200 Vrms. Further, as indicated by the gate signals, the arm switching is performed, and a boost pulse voltage that rises from a near-zero voltage of a rectangular waveform with a high-frequency pulse is generated between the busbar PNs.

### Embodiment 4

### Vertical Half Bridging of a MERS at the Time of a Single-Phase AC Input

A soft switching power converter according to Embodiment 4 of the present invention is now described.

FIG. 15 shows an example case where the bridge circuit in the boost pulse voltage generating unit 3 is replaced with a simpler one.

More specifically, FIG. 15 illustrates an example case where each of the reverse-conduction semiconductor switches S1 and S4 of the bridge circuit in the boost pulse voltage generating unit 3 of Embodiment 1 (FIG. 7) of the present invention is replaced with a diode, and a half-bridge structure is formed. Although two capacitors are required in the vertical half-bridge structure, the number of reverse-conduction semiconductor switches is halved. This embodiment is particularly effective in power conversions of three-phase AC inputs.

### Embodiment 5

### First Embodiment of a Switching Control Unit

A soft switching power converter according to Embodiment 5 of the present invention is now described.

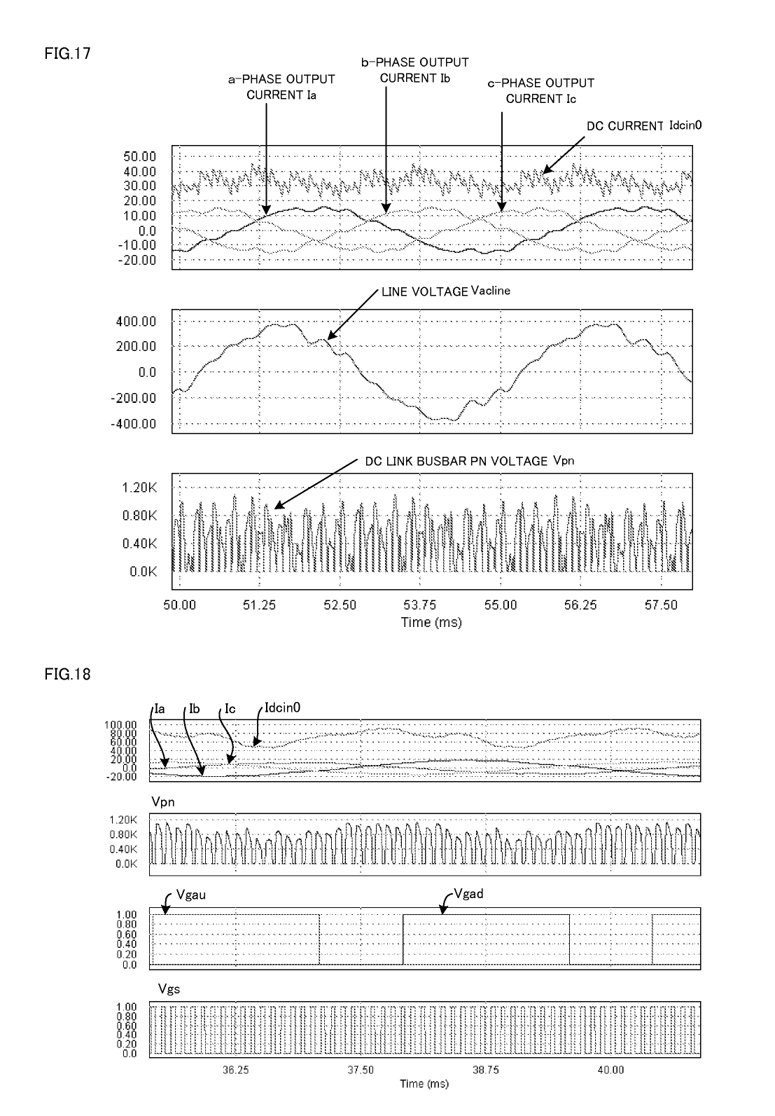

FIG. 16 illustrates an embodiment of a DC-to-three-phase AC conversion. FIGS. 17 and 18 show the results of a computer simulation of the conversion illustrated in FIG. 16.

More specifically, FIG. 16 is a block diagram of a circuit in which low-speed polarity changing switches (T1 through T6) are used as the switching control unit 5 of Embodiment 1 of the present invention for switching DC outputs to three-phase AC (FIG. 7). A three-phase AC load is connected as a load to this circuit. FIG. 17 shows the input DC current Idcin0, the respective phase output currents (Ia, Ib, and Ic), the line voltage Vacline, and the busbar PN voltage Vpn shown in FIG. 16. FIG. 18 shows the waveforms of the gate signal Vgau of the low-speed polarity changing switch T1 of FIG. 16, the gate signal Vgad of the low-speed polarity changing switch T2, and the gate signal Vgs of the reverse-conduction semiconductor switches S1 and S3.

The switching frequency of the reverse-conduction semiconductor switches of FIG. 16 is 10 kHz. The low-speed polarity changing switches (T1 through T6) of the switching control unit 5 switch in synchronization with the periods in which the busbar PN voltage Vpn becomes almost zero. Although a voltage source capacitor is required in a conventional voltage-type inverter, the capacitor of the MERS that stores and recovers the magnetic energy also serves as the voltage source capacitor in this embodiment. Even if the energy of each pulse is small, the link frequency is high, and the energy per unit time is multiplied by the frequency of the energy of each pulse. Accordingly, the capacitor can convert a large amount of electric energy with a small capacitance. It is also possible to perform reverse conversions that cannot be performed by a conventional voltage-type inverter.

### Embodiment 6

### Second Embodiment of a Switching Control Unit

A soft switching power converter according to Embodiment 6 of the present invention is now described.

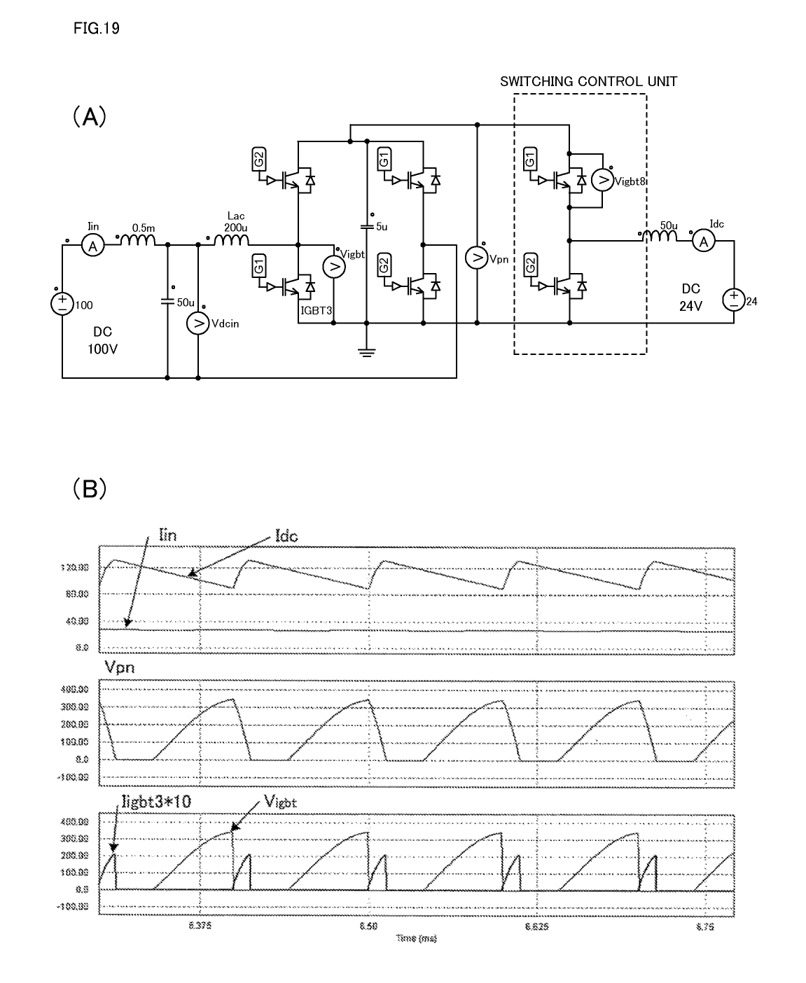

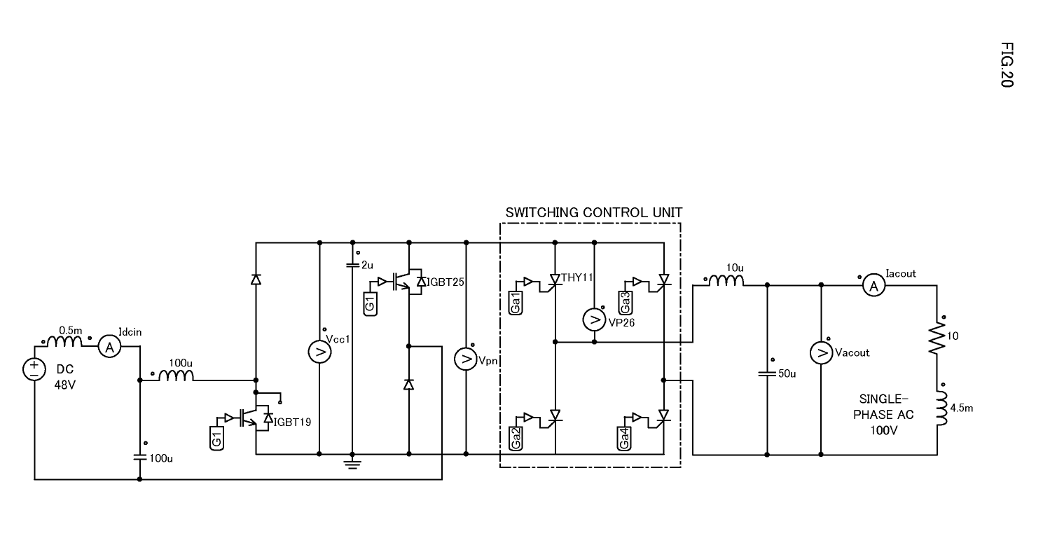

FIG. 19(A) illustrates an embodiment of a DC-to-DC conversion. FIG. 19(B) shows the results of a computer simulation of the conversion illustrated in FIG. 19(A).

More specifically, FIG. 19(A) is a block diagram of a circuit in which a semiconductor switch leg that connects two semiconductor switches in series is used as the switching control unit 5. This circuit outputs a DC power generated by lowering a boost pulse voltage through switching on and off of the semiconductor switches. Unlike the circuit of Embodiment 2 (FIG. 12) of the present invention, this circuit can obtain a lowered DC output. FIG. 19(B) shows the waveforms of the input current Iin, the output current Idc, the busbar PN voltage Vpn, and the voltage Vigbt and the current Iigbt3 to be applied to the reverse-conduction semiconductor switch S3 (the currents shown in the drawings being tenfold).

In FIG. 19(A), a DC of 100 V can be lowered to a DC of 24V. The gate signal G1 to be applied to the gates of the reverse-conduction semiconductor switches S1 and S3 is turned on and off at a switching frequency of 10 kHz and a duty ratio of 0.4. The gate signal G2 to be applied to the gates of the reverse-conduction semiconductor switches S2 and S4 is always off. If the gate signals G1 and G2 are swapped, a reverse conversion can be performed by controlling the reverse-conduction semiconductor switches. In other words, a reverse conversion from the side of the input power supply 1 (a DC of 24 V) to the side of the DC power supply or the load 7 (a DC of 100 V) can be performed.

As can be seen from FIG. 19(B), while the input current Iin is 26 A, the output current Idc is 110 A. Although the busbar PN voltage Vpn is up to 340 Vpp, the output voltage is lowered, and the output current is increased by the switching control unit 5. Also, as can be seen from FIG. 19(B), switching is performed at a near-zero voltage when the reverse-conduction semiconductor switch S3 is turned off, and switching is performed with a near-zero current when the reverse-conduction semiconductor switch S3 is turned on. In other words, soft switching is performed.

### Embodiment 7

### Example Case where Thyristors are Used as the Low-Speed Polarity Changing Switches of the Switching Control Unit, or Four Semiconductor Switches Connected in Series are Used as a Semiconductor Switching Leg

A soft switching power converter according to Embodiment 7 of the present invention is now described.

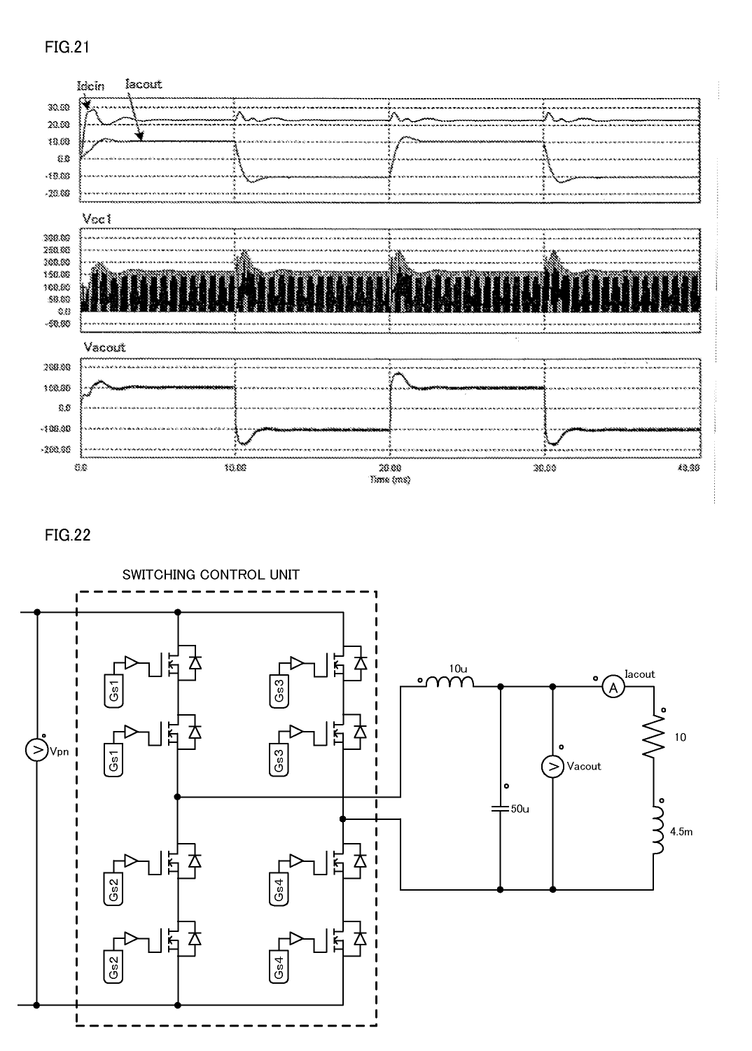

FIG. 20 illustrates an embodiment of a DC-to-single-phase AC conversion for which thyristors are used as the switching control unit 5. FIG. 21 shows the results of a computer simulation of the conversion illustrated in FIG. 20.

More specifically, FIG. 20 is a block diagram of a circuit for converting a DC of 48 V to a single phase of 100 V, 50 Hz. FIG. 21 shows the waveforms of the input DC current Idcin, the output AC current Iacout, the busbar PN voltage Vpn, and the output AC voltage Vacout shown in FIG. 20.

FIG. 20 illustrates an example case where a reverse conversion from AC to DC is not performed. The boost pulse voltage generation from DC provides an on/off gate signal to the reverse-conduction semiconductor switches S1 and S3, and provides a constantly-off gate signal to the reverse-conduction semiconductor switches S2 and S4. Since the reverse-conduction semiconductor switches S2 and S4 can be used only in diode operations, reverse-conduction semiconductor switches are not used, but diodes are used in place of the reverse-conduction semiconductor switches S2 and S4.

FIG. 22 shows an example case where four semiconductor switches connected in series are used as a semiconductor switch leg of the switching control unit 5. This arrangement has the advantage that each semiconductor switch is required to have only low voltage resistance. This is because the switching operations of all the semiconductor elements are performed at zero voltage and zero current, and semiconductor switches of low-speed switching operations can be used accordingly.

### Embodiment 8

### Example Case where a Smoothing Inductor is Replaced with a Diode

A soft switching power converter according to Embodiment 8 of the present invention is now described.

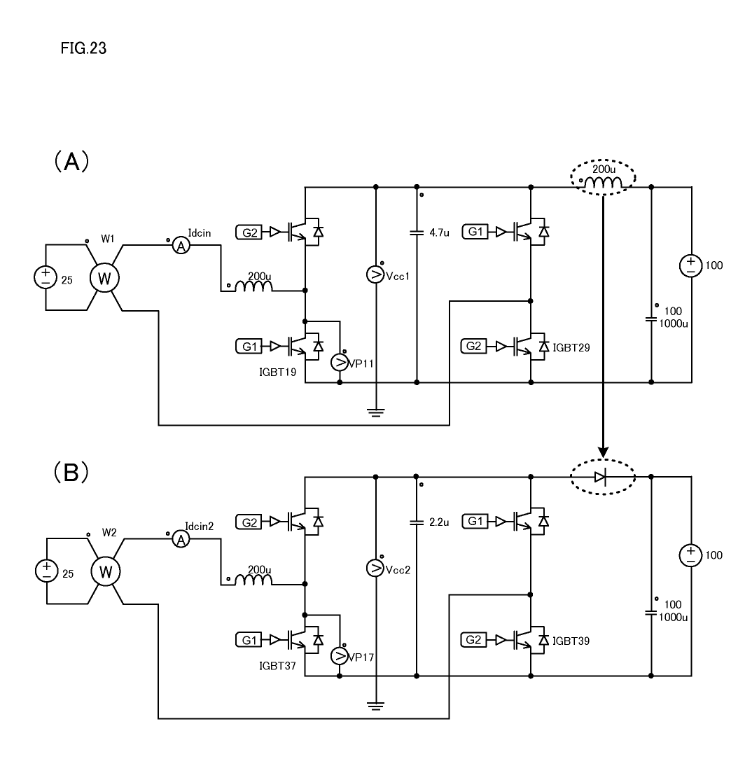

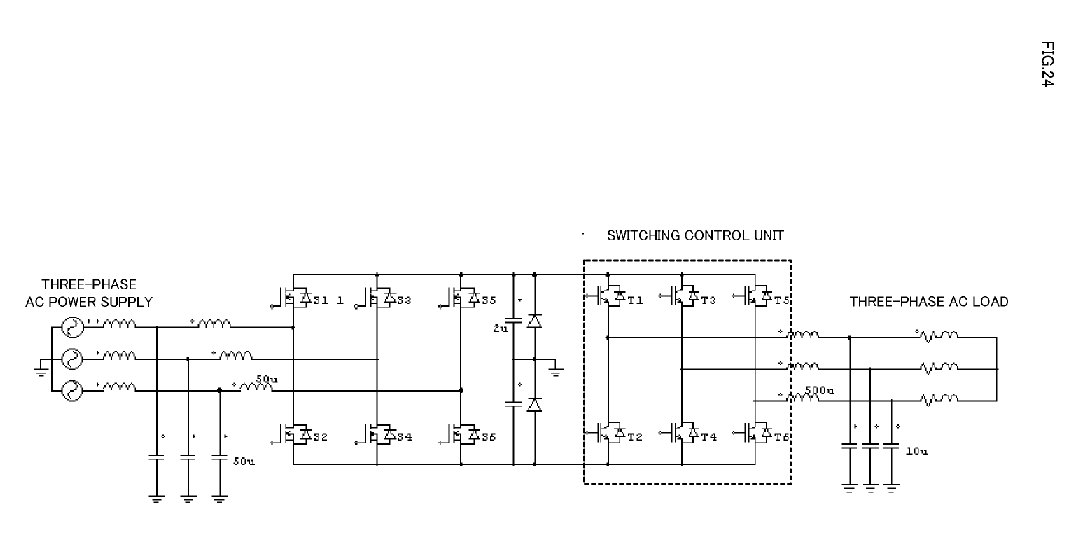

FIG. 23(B) is an example case where a diode is used in place of the smoothing inductor 6.

More specifically, in the Embodiment illustrated in FIG. 23(B), a diode, instead of the smoothing inductor 6, is used as a unit which smoothens a boost pulse voltage. FIG. 23(A) shows an Embodiment of a reversible DC-to-DC conversion for which a smoothing inductor is used, and this conversion is the same as Embodiment 2 (FIG. 12) of the present invention.

As shown in FIG. 23(B), reversible conversions cannot be performed where the smoothing unit is changed to a diode. However, this arrangement has the advantage that the boost pulse voltage is lowered. A diode or a smoothing inductor should be selected as the smoothing unit, only after a careful comparison between the conduction loss at a diode and the loss at a smoothing inductor. If an output DC voltage is clamped by a diode, the boost pulse voltage is halved, and the output power is also halved. However, this arrangement has the advantage that the power converter can be made smaller in size.

### Embodiment 9

### Example of a Conversion from a Three-Phase AC Power Supply to a Three-Phase AC Load

A soft switching power converter according to Embodiment 9 of the present invention is now described.

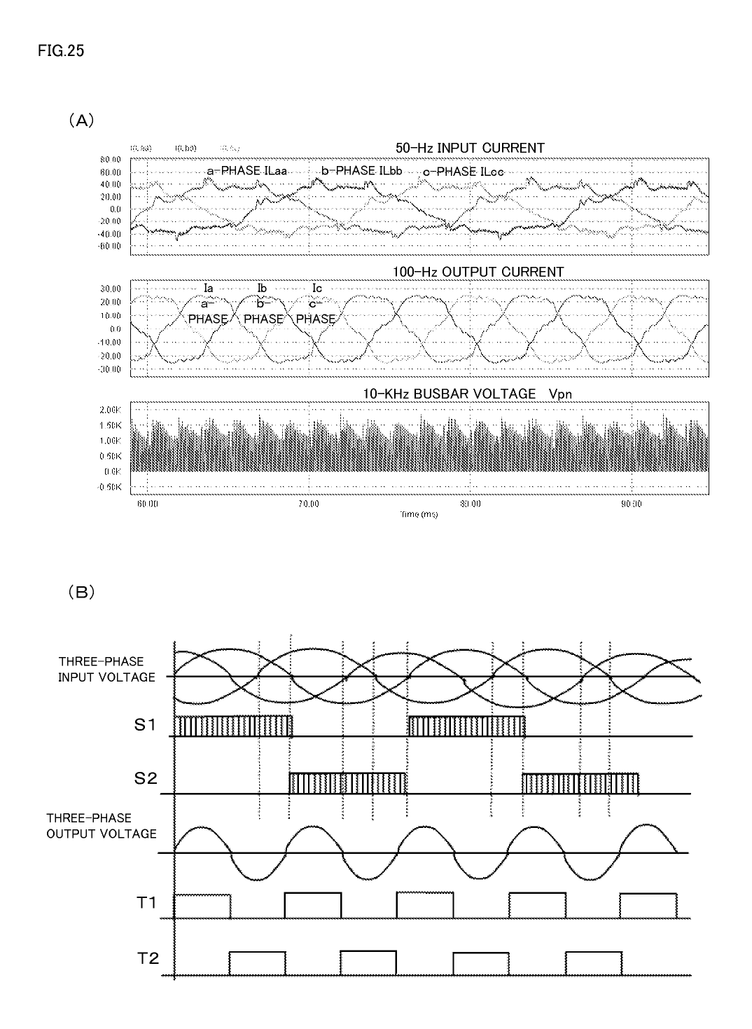

FIG. 24 is an embodiment of a conversion from a three-phase AC power supply to a three-phase AC load. FIG. 25(A) shows the results of a computer simulation of the circuit illustrated in FIG. 24. FIG. 25(B) shows the timings of switching the reverse-conduction semiconductor switches and the low-speed polarity changing switches of the switching control unit 5.

More specifically, FIG. 24 is a block diagram of a conversion circuit in which the DC output of Embodiment 3 (FIG. 13) of the present invention is replaced with a three-phase AC output that is the same as an input. FIG. 25A shows the waveforms of the respective phase input currents (ILaa, ILbb, and ILcc), the respective phase output currents (Ia, Ib, and Ic), and the busbar PN voltage Vpn shown in FIG. 24. FIG. 25(B) shows the waveforms of the three-phase AC input voltage, the gate signals for the reverse-conduction semiconductor switches S1 and S2, the three-phase AC output voltage, and the gate signals for the low-speed polarity changing switches T1 and T2 shown in FIG. 24.

As a conventional art, there is an AC-to-AC direct conversion circuit that is called a matrix converter (hereinafter referred to as MC). This circuit does not include a voltage source capacitor, but requires an AC switch that has a blocking capability in both forward and backward directions. In a case where an input and an output are three-phase AC, the number of semiconductor elements to be used is nine, but the structures of the semiconductor elements to be used are complicated, resulting in a cost increase.

On the other hand, the conversion circuit of FIG. 24 for converting three-phase AC to three-phase AC is realized by semiconductor elements that do not have a reverse blocking capability and is capable of performing switching on and off only in the forward direction. In other words, the circuit of FIG. 24 includes reverse-conduction semiconductor switches. Although the number of semiconductor elements to be used is twelve, the structures of the semiconductor elements to be used are simple, and the costs can be lowered. The control method here is the same as a conventional direct link method that is simple. Further, this circuit has the advantage that the DC busbar voltage can be made higher than the input power supply voltage, which cannot be performed in the MC. In this Embodiment, two capacitors store magnetic energy, and discharge the energy until the voltage becomes almost zero in each control cycle. Accordingly, switching is performed at a near-zero voltage when the semiconductor switches used for all the switching are turned off, and switching is performed with a near-zero current when the semiconductor switches are turned on. In this manner, soft switching is performed. This is a feature that is not seen in the conventional MC.

1. (canceled)

2. A soft switching power converter that performs a conversion from AC power to DC power or a reverse conversion from DC power to AC power through soft switching, the power converter comprising:
a boost pulse voltage generating unit (3) that uses an AC power supply or a DC power supply reversing current polarity as an input power supply (1), and is input the input power supply (1) to AC input terminals (a, b) thereof via an AC inductor (2);
a switching control unit (5) that is formed with one or a plurality of semiconductor switch legs connected in parallel, each semiconductor switch leg having an output terminal that is a point at which two semiconductor switches are connected in series, the switching control unit (5) having an input terminal connected to DC output terminals (c, d) of the boost pulse voltage generating unit (3), the switching control unit (5) performing on/off control alternately on a boost pulse voltage generated by the boost pulse voltage generating unit (3) based on a pulse width modulation (PWM) carrier signal synchronized with a generation period of the boost pulse voltage to switch polarity of power that is output to the output terminal;
a smoothing inductor (6) that is inserted in series between the output terminal of the switching control unit (5) and a load (7), and smoothens and supplies the boost pulse voltage to the load (7); and
a control unit (4) that controls the boost pulse voltage generating unit (3) and the switching control unit (5); wherein
the boost pulse voltage generating unit (3) being a single-phase full-bridge magnetic energy recovering switch, the single-phase full-bridge magnetic energy recovering switch including: a bridge circuit formed with four reverse-conduction semiconductor switches (S1, S2, S3, and S4); and a capacitor (31) that is connected between DC output terminals (c, d) of the bridge circuit, and recovers and stores magnetic energy of current,
the control unit (4) applying a control signal to gates so that at least one pair of reverse-conduction semiconductor switches (a pair of S1 and S3, or a pair of S2 and S4) located on a diagonal of the bridge circuit are turned on and off at the same time, the control unit (4) setting an on/off period of the reverse-conduction semiconductor switches longer than a resonance period determined by a capacitance of the capacitor (31) and an inductance (Lac) of the AC inductor (2).

3. The soft switching power converter according to claim 2, wherein,
when power to be supplied to the load (7) is DC, the number of the semiconductor switching legs is one, and the boost pulse voltage is lowered and supplied to the load by turning on and off the semiconductor switches;
when the power to be supplied to the load (7) is single-phase AC, the number of the semiconductor switch legs is two, and control is performed by turning on and off the semiconductor switches, to generate a low-frequency single-phase AC voltage;
when the power to be supplied to the load (7) is three-phase AC, the number of the semiconductor switch legs is three, and control is performed by turning on and off the semiconductor switches, to generate a three-phase AC voltage; or
when the power to be supplied to the load (7) is N-phase AC, the number of the semiconductor switch legs is N, and control is performed by turning on and off the semiconductor switches, to generate an N-phase AC voltage.

4. The soft switching power converter according to claim 2, wherein
when the input power supply (1) is DC, the control unit (4) turns on and off only one pair of the reverse-conduction semiconductor switches (a pair of S1 and S3, or a pair of S2 and s4) located on a diagonal of the bridge circuit, while maintaining the other pair of the reverse-conduction semiconductor switches in an off state, to thereby control the reverse-conduction semiconductor switches to operate as diodes.

5. The soft switching power converter according to claim 2, wherein
the boost pulse voltage generating unit (3) is a single-phase vertical half-bridge magnetic energy recovering switch, the single-phase vertical half-bridge magnetic energy recovering switch including: a half-bridge circuit formed with two series-connected reverse-conduction semiconductor switches (S2 and S3) of the reverse-conduction semiconductor switches and two series-connected diodes; and two of the capacitors (31) that are respectively connected in parallel to the two series-connected diodes.

6. The soft switching power converter according to claim 2, wherein
when the input power supply (1) is a three-phase AC power supply, the boost pulse voltage generating unit (3) is a three-phase vertical half-bridge magnetic energy recovering switch, the three-phase vertical half-bridge magnetic energy recovering switch including: a three-phase full-wave bridge circuit that is formed with six of the reverse-conduction semiconductor switches in the form of three of the reverse-conduction semiconductor switch legs, each reverse-conduction semiconductor switch leg being formed with two series-connected reverse-conduction semiconductor switches of the reverse-conduction semiconductor switches; and a circuit that is connected between DC terminals of the three-phase full-wave bridge circuit, and has a first capacitor and a first diode that are connected in parallel, the parallel-connected first capacitor and the first diode being connected in parallel to a second capacitor and a second diode that are connected in parallel so that the first diode and the second diode are orientated in a forward direction, a midpoint of the series connection being connected to a neutral point of the three-phase AC power supply, and
the reverse-conduction semiconductor switches of a direction of a three-phase AC current are selected from the reverse-conduction semiconductor switch legs each connecting two of the reverse-conduction semiconductor switches, and all the selected reverse-conduction semiconductor switches are turned on and off at the same time, to generate the boost pulse voltage between the DC terminals of the three-phase full-wave bridge circuit, a three-phase AC power conversion being thereby performed.

7. The soft switching power converter according to claims 2, wherein
thyristors are used as the semiconductor switches of the switching control unit (5).

8. The soft switching power converter according to claims 2, wherein,
instead of the smoothing inductor (6), a diode is used as a unit for smoothing the boost pulse voltage.

9. The soft switching power converter according to claim 2, wherein,
when power MOSFETs each having a parasitic diode built therein are used as the four reverse-conduction semiconductor switches (S1, S2, S3, and S4), a synchronization signal is transmitted at the time of reverse conduction of the reverse-conduction semiconductor switches, to reduce conduction loss.

10. The soft switching power converter according to claims 2, wherein,
based on an input voltage or an input current of the boost pulse voltage generating unit (3), a voltage and a current of a DC output or an AC output switched through the pulse width modulation, and a voltage of the capacitor (31), the control unit (4) determines an on/off time ratio of the gate signal and a switching period, and performs on/off control on the reverse-conduction semiconductor switches.

11. The soft switching power converter according to claim 2, wherein
the semiconductor switch legs of the switching control unit (5) are replaced with four series-connected semiconductor switches.

12. The soft switching power converter according to claim 3, wherein,
when the input power supply (1) is three-phase AC, and the power to be supplied to the load (7) is three-phase AC, the reverse-conduction semiconductor switches are used as the semiconductor switches of the switching control unit (5).
